(19) United States
(12) Patent Application Publication
(10) Pub. No.: US 2025/0245680 A1
(43) Pub. Date: Jul. 31, 2025

(54) SYSTEMS AND METHODS TO IDENTIFY CUSTOMER ISSUES UTILIZING CAUSAL AND SEQUENTIAL PATTERNS

(71) Applicant: Verizon Patent and Licensing Inc., Basking Ridge, NJ (US)

(72) Inventors: Subham BISWAS, Thane (IN); Keerthivasan MADURAI, Chengalpattu (IN)

(73) Assignee: Verizon Patent and Licensing Inc., Basking Ridge, NJ (US)

(21) Appl. No.: 18/422,488

(22) Filed: Jan. 25, 2024

(51) Int. Cl. G06Q 30/0201; G06Q 30/015

(52) U.S. Cl. CPC G06Q 30/0201; G06Q 30/015

(57) ABSTRACT

A device may receive channel data associated with digital channels utilized by a customer, and may identify, in the channel data, potential issues and sequential events for the potential issues. The device may generate a causal relationship graph based on the sequential events and the potential issues, and may process the causal relationship graph, with a machine learning model, to identify issues of the customer and events associated with the issues. The device may apply causal inference to identify causal relationships between the issues and the events, and may calculate an inference score for the issues and the events based on the causal relationships. The device may modify, based on the inference score, a customer journey defined by the events to generate a modified customer journey, and may perform one or more actions based on the modified customer journey.

### BACKGROUND

A user device (e.g., a mobile telephone, a tablet computer, a desktop computer and/or the like) may utilize applications that enable the user device to generate digital channel data via calls, live chats, interactive voice responses (IVR), inputs to chatbots, inputs to point-of-sale (PoS) systems, and/or the like.

### BRIEF DESCRIPTION OF THE DRAWINGS

FIGS. 1A-1G are diagrams of an example associated with identifying customer issues utilizing causal and sequential patterns.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for identifying customer issues utilizing causal and sequential patterns.

### DETAILED DESCRIPTION OF EXAMPLE EMBODIMENTS

The following detailed description of example implementations refers to the accompanying drawings. The same reference numbers in different drawings may identify the same or similar elements.

Customer service representatives may service customers based on channel data (e.g., digital channel data) associated with associated digital channels, such as calls, live chats, IVR inputs, inputs to chatbots, inputs to POS systems, and/or the like. The customer service representatives may attempt to understand how best to serve the customers based on the digital channel data, but may fail to understand root causes and sequence patterns (e.g., an ordered set of events with a pattern) of issues associated with the customers. Without understanding the root causes and the sequence patterns of issues, customer service representatives may provide solutions for customers that only address surface-level symptoms, which may lead to recurring problems and frustrated customers. Without insights into the sequence patterns of issues that the customer has faced, the customer service representatives may struggle to provide timely and relevant assistance to customers, which may lead to longer resolution times and lower customer satisfaction. Thus, current techniques for providing customer service consume computing resources (e.g., processing resources, memory resources, communication resources, and/or the like), networking resources, and/or other resources associated with failing to identify root causes of customer issues, failing to identify the sequence patterns of the customer issues, providing incorrect solutions to the customers, causing longer resolution times and recurring customer problems, and/or the like.

Some implementations described herein provide an issue identification system that identifies customer issues utilizing causal and sequential patterns. For example, the issue identification system may receive channel data associated with digital channels utilized by a customer, and may identify, in the channel data, potential issues and sequential events for the potential issues. The issue identification system may generate a causal relationship graph based on the sequential events and the potential issues, and may process the causal relationship graph, with a machine learning model, to identify issues of the customer and events associated with the issues. The issue identification system may apply causal inference to identify causal relationships between the issues and the events, and may calculate an inference score for the issues and the events based on the causal relationships. The issue identification system may modify, based on the inference score, a customer journey defined by the events to generate a modified customer journey, and may perform one or more actions based on the modified customer journey.

In this way, the issue identification system identifies customer issues utilizing causal and sequential patterns. For example, the issue identification system may generate a knowledge graph based on digital channel data associated with a customer, and may process the knowledge graph, with a machine learning model, to identify issues associated with the customer. The issue identification system may identify causal relationships between the issues, and may generate an inference score based on the causal relationships between the issues. The issue identification system may modify a journey of the customer based on the inference score in order to eliminate the issues associated with the customer. Thus, the issue identification system may conserve computing resources, networking resources, and/or other resources that would have otherwise been consumed by failing to identify root causes of customer issues, failing to identify the sequence patterns of the customer issues, providing incorrect solutions to the customers, causing longer resolution times and recurring customer problems, and/or the like.

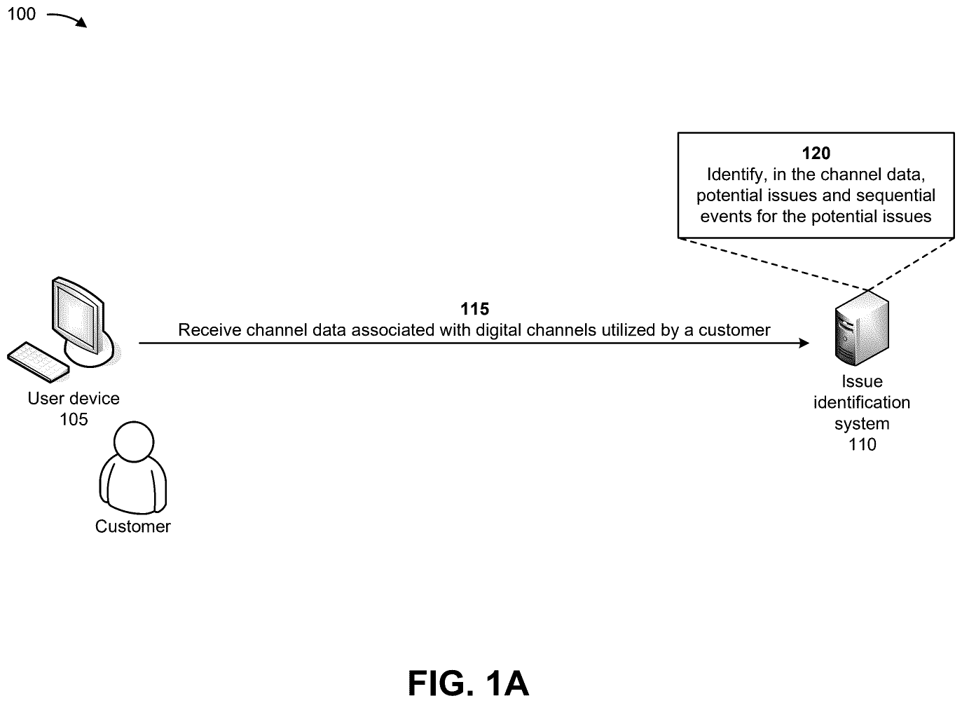

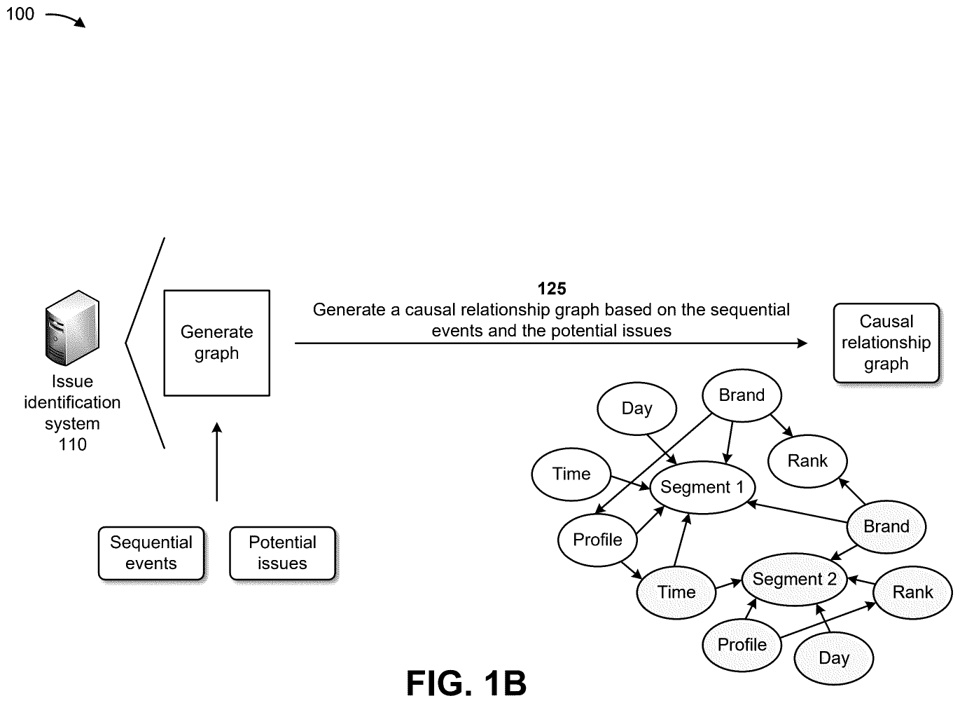

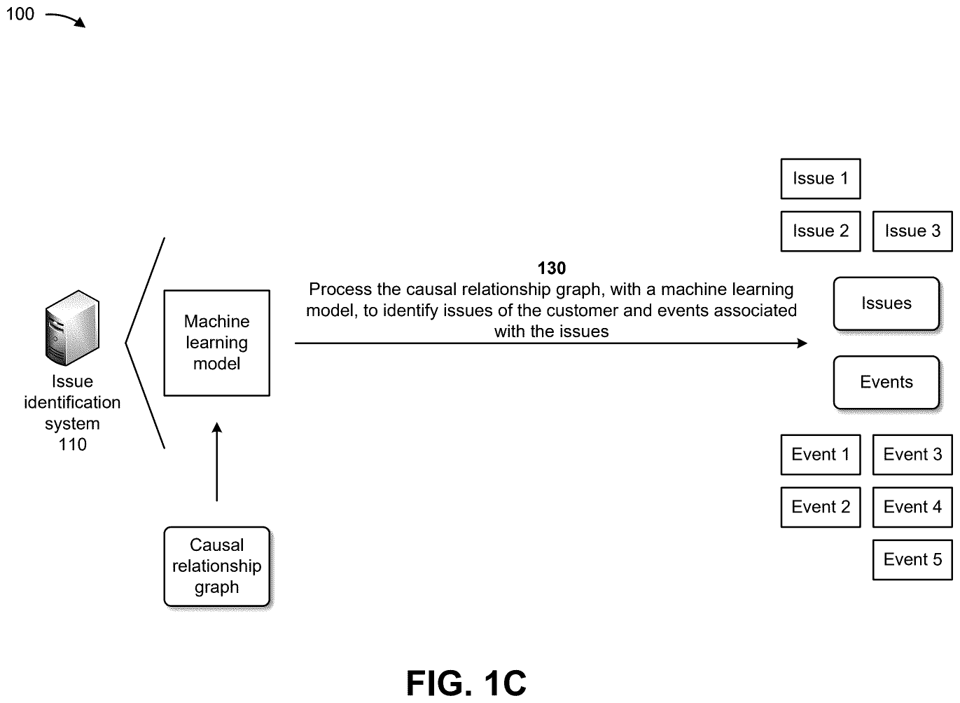

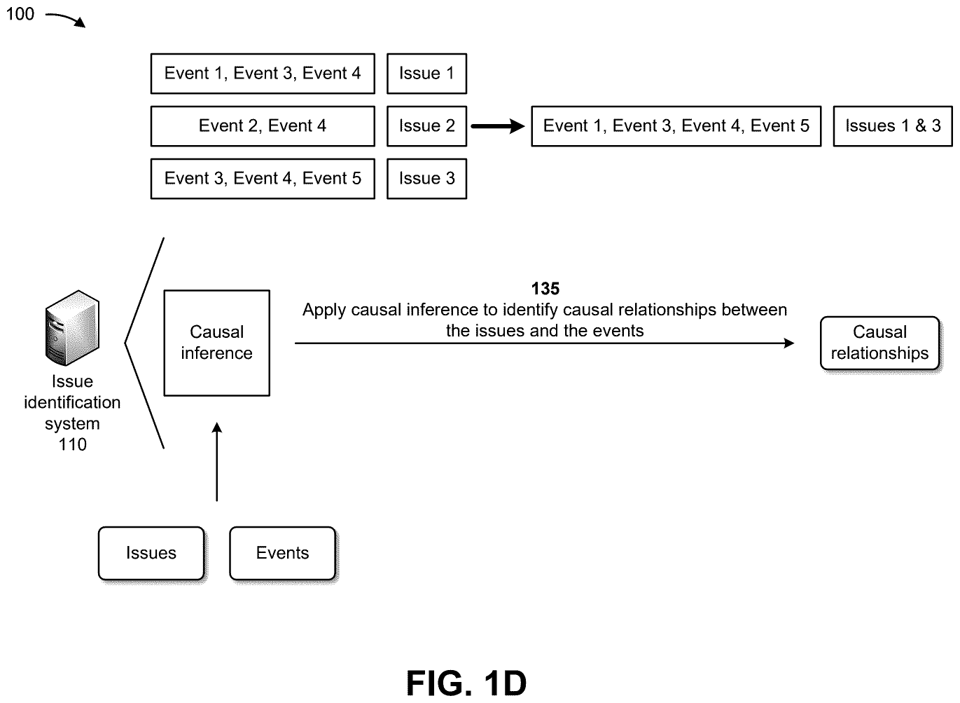

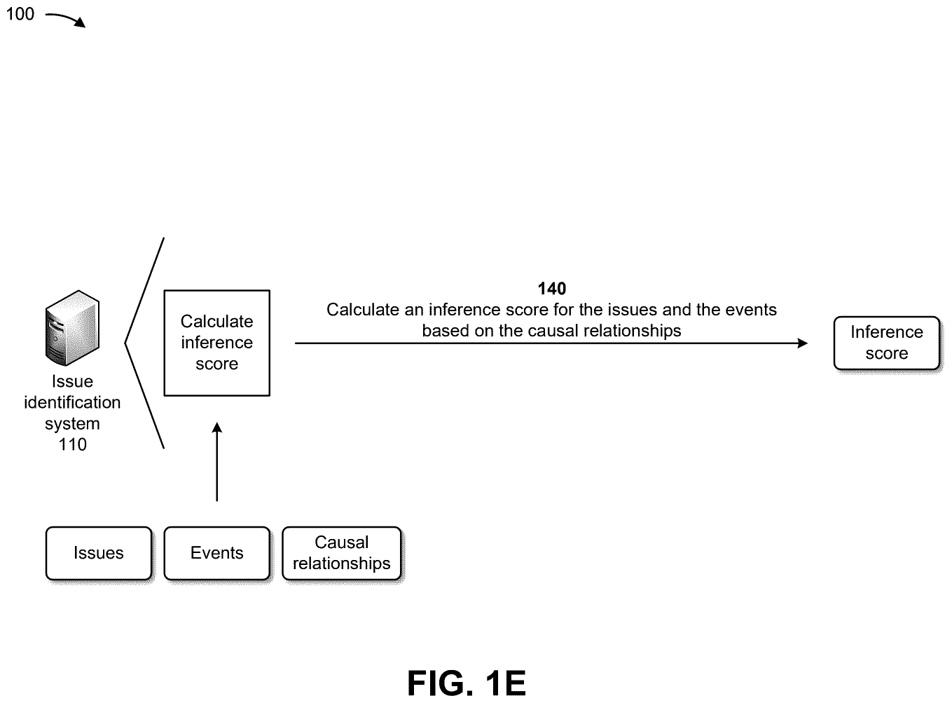

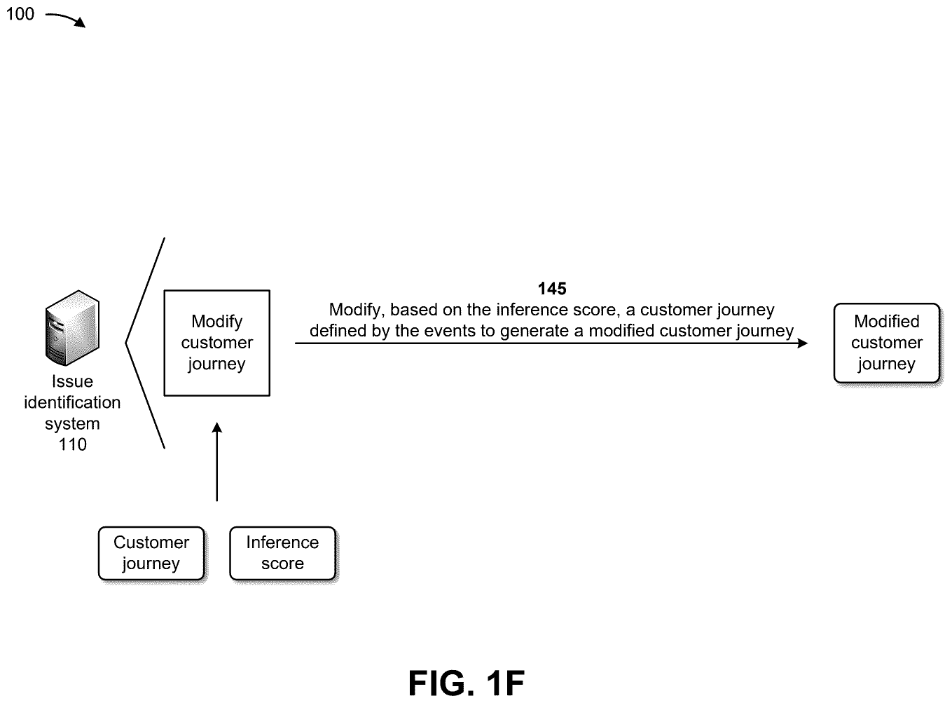

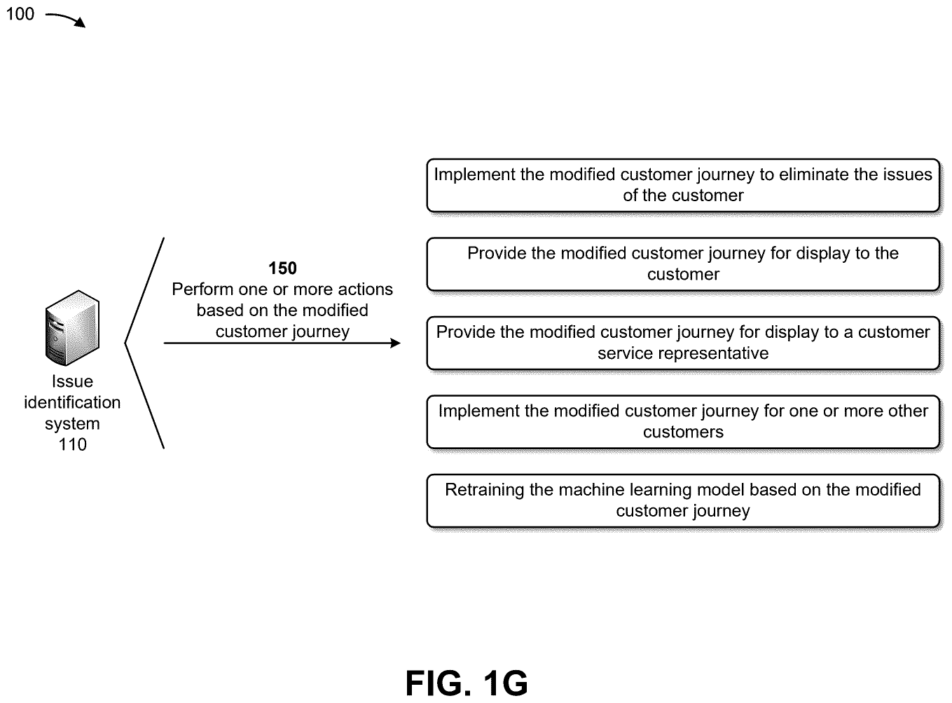

FIGS. 1A-1G are diagrams of an example 100 associated with identifying customer issues utilizing causal and sequential patterns. As shown in FIGS. 1A-1G, example 100 includes a user device 105 associated with a customer and an issue identification system 110. Further details of the user device 105 and the issue identification system 110 are provided elsewhere herein.

As shown in FIG. 1A, and by reference number 115, the issue identification system 110 may receive channel data associated with digital channels utilized by the customer. For example, the customer may utilize the user device 105 to conduct a telephone call (e.g., with a customer service representative), to conduct a live chat (e.g., with a customer service representative), to provide an interactive voice response (IVR) to an IVR system, to provide an input to a chatbot, to provide an input to a point-of-sale (POS) system, to provide an input to a web application (e.g., executing on the user device 105), to provide an input to a mobile application (e.g., executing on the user device 105), and/or the like. For example, the user device 105 may provide a web application, a mobile application, a chatbot application, a live chat application, an IVR system application, a voice or video call application, and/or the like. The customer may utilize the applications to cause the user device 105 to conduct voice or video calls, conduct live chats, provide interactive voice responses to the IVR system, provide inputs to chatbots, and/or the like.

In one example, the channel data may include data identifying events associated with the customer, such as the customer viewing or listening to account data associated with the customer, the customer viewing or listening to a service plan associated with the customer, the customer changing a service plan, the customer discontinuing a service plan, the customer ordering a product or a service, the customer reporting an issue with a product or a service, and/or the like. The user device 105 may provide the channel data to the issue identification system 110, and the issue identification system 110 may receive the channel data. In some implementations, the issue identification system 110 may continuously receive the channel data in real time from the user device 105, may periodically receive the channel data from the user device 105, may receive the channel data from the user device 105 based on requesting the channel data from the user device 105, and/or the like.

As further shown in FIG. 1A, and by reference number 120, the issue identification system 110 may identify, in the channel data, potential issues and sequential events for the potential issues. For example, the issue identification system 110 may analyze the channel data to identify the events, and may order the events in a sequential order to generate sequential events. The issue identification system 110 may determine whether the sequential events may cause one or more potential issues. In one example, the sequential events may include the customer viewing account data, viewing a service plan, and changing the service plan. The issue identification system 110 may determine that such sequential events may cause a promotion for the customer to be disabled (e.g., a potential issue). In another example, the sequential events may include the customer viewing a service plan and discontinuing the service plan. The issue identification system 110 may determine that such sequential events may cause costs for the customer to increase (e.g., a potential issue). In some implementations, the issue identification system 110 may identify the potential issues in the channel data based on comparing the channel data to historical channel data that resulted in issues for customers. If the channel data matches the historical channel data, the issue identification system 110 may identify the potential issues as indicated by the historical channel data.

As shown in FIG. 1B, and by reference number 125, the issue identification system 110 may generate a causal relationship graph based on the sequential events and the potential issues. For example, the issue identification system 110 may generate nodes that represent the sequential events and may determine relationships between the sequential events. The issue identification system 110 may generate connectors that represent the relationships between the sequential events, and may provide the connectors between the nodes that represent the sequential events. The nodes and the connectors may form a knowledge graph, referred to as a causal relationship graph.

In some implementations, when generating the causal relationship graph based on the sequential events and the potential issues, the issue identification system 110 may map the sequential events to one or more of the potential issues, and may create a cross-issue sequential event mapping based on the sequential events and the potential issues. In some implementations, the issue identification system 110 may utilize a cross-sequential model that combines both a longitudinal design and a cross-sectional design when creating the cross-issue sequential event mapping. The cross-issue sequential event mapping may create new connectors or paths between the sequential events that did not previously exist. The issue identification system 110 may utilize the mapping of the sequential events to the one or more of the potential issues, and the cross-issue sequential event mapping to generate the causal relationship graph.

In some implementations, when generating the causal relationship graph based on the sequential events and the potential issues, the issue identification system 110 may identify a set of the sequential events for each of the potential issues. The issue identification system 110 may assign an importance to each of the sequential events relative to each of the potential issues, and may rank the sequential events based on the importance assigned to each of the sequential events. In some implementations, the issue identification system 110 may utilize explainable artificial intelligence, a recency, frequency, and monetary (RFM) model, and/or the like to determine the ranking of the sequential events. The issue identification system 110 may select the set of the sequential events from the sequential events based on the rankings of the sequential events (e.g., the set may include a top ten ranked sequential events, a top twenty ranked sequential events, and/or the like). The issue identification system 110 may map the set of the sequential events to each of the potential issues, and may create a cross-issue sequential event mapping based on the set of the sequential events and the potential issues. The issue identification system 110 may utilize the mapping of the set of sequential events to each of the potential issues, and the cross-issue sequential event mapping, to generate the causal relationship graph.

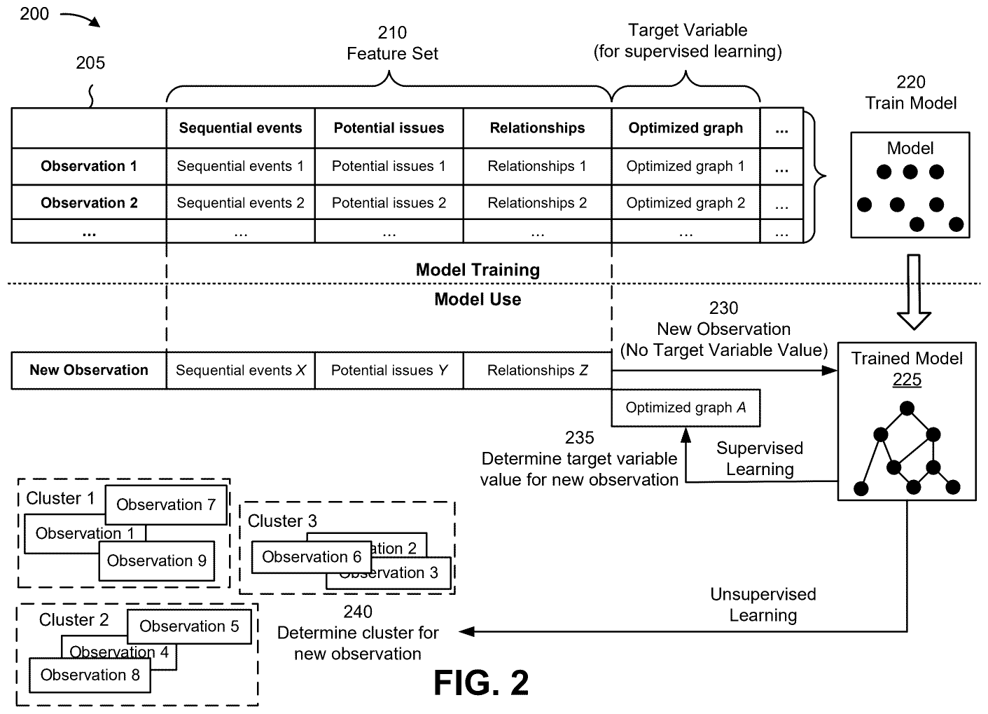

As shown in FIG. 1C, and by reference number 130, the issue identification system 110 may process the causal relationship graph, with a machine learning model, to identify issues of the customer and events associated with the issues. For example, the issue identification system 110 may be associated with or may generate a machine learning model that predicts (e.g., in real time or near-real time) whether the customer has an issue, and that identifies the issue when the issue for the customer is predicted by the machine learning model. Further details associated with the machine learning model and training the machine learning model are provided below in connection with FIG. 2. In some implementations, when processing the causal relationship graph, with the machine learning model, to identify the issues of the customer and the events associated with the issues, the issue identification system 110 may utilize the machine learning model to reduce a size of the causal relationship graph to only include the issues relevant to the customer and the events associated with the issues and relevant to the customer. For example, the machine learning model may remove, from the causal relationship graph, nodes and/or connectors that are associated with issues and/or events that are irrelevant to the customer based on the processing the causal relationship graph with the machine learning model.

As shown in FIG. 1D, and by reference number 135, the issue identification system 110 may apply causal inference to identify causal relationships between the issues and the events. For example, causal inference is a technique for determining an independent and actual effect of a particular phenomenon that is a component of a larger system. In some implementations, the issue identification system 110 may utilize Pearl's structural causal model as the causal inference technique to identify the causal relationships between the issues and the events. Pearl's structural causal model may include a three-level system that provides an understanding of causality. A first level (e.g., an association level) may utilize associations that statistics can measure. The first level may include conditional probabilities, correlations, machine learning (e.g., a neural network model that predicts some data from other data), and/or the like. A second level (e.g., an intervention level) may include identifying questions to be answered. For example, if a business action is performed, then what will happen; if customers are given a discount, how much longer will the customers stay; if a new feature is added, how much will customer lifetime value change; and/or the like. A third level may include identifying questions that provide a full understanding of causality. While the second level questions are about an effect of any cause, the third level questions are about a cause of any effect.

In some implementations, when applying causal inference (e.g., Pearl's structural causal model) to identify the causal relationships between the issues and the events, the issue identification system 110 may determine associations between the issues and the events, and may determine effects of interventions in the events based on the associations. The issue identification system 110 may identify the causal relationships between the issues and the events based on the effects of the interventions in the events. In some implementations, the issue identification system 110 may utilize another causal inference technique to identify the causal relationships between the issues and the events, such as a causal pie model, a structural equation model, a Rubin causal model, and/or the like.

As shown in FIG. 1E, and by reference number 140, the issue identification system 110 may calculate an inference score for the issues and the events based on the causal relationships. For example, the issue identification system 110 may process the issues, the events, and the causal relationships, with a model, to calculate an inference score that provides an indication of a similarity between the issues and the events. In some implementations, the model may include a similarity-based inference model, such as a k-nearest neighbor classifier model utilized in instance-based learning. The similarity-based inference model may determine similarities between the issues and the events based on the causal relationships, and may assign scores to the similarities to generate similarity scores. The similarity-based inference model may combine the similarity scores to generate the inference score. In some implementations, the similarity-based inference model may assign scores and weights to the similarities to generate weighted similarity scores, and may combine the weighted similarity scores to generate the inference score.

As shown in FIG. 1F, and by reference number 145, the issue identification system 110 may modify, based on the inference score, a customer journey defined by the events to generate a modified customer journey. For example, the events associated with the customer may define a customer journey for the customer. A customer journey describes a path of interactions that a customer has with a brand, a product, a service, and/or the like. The customer journey describes both direct interactions (e.g., the customer contacting a customer service representative) and indirect interactions (e.g., the customer learning about a brand at an event). In some implementations, the customer journey may cause the customer to experience one or more issues, resulting in customer frustration, potential loss of the customer, and/or the like. The issue identification system 110 may utilize the inference score to modify or remap the customer journey to generate the modified customer journey that eliminates the one or more issues experienced by the customer during the customer journey.

As shown in FIG. 1G, and by reference number 150, the issue identification system 110 may perform one or more actions based on the modified customer journey. In some implementations, performing the one or more actions includes the issue identification system 110 implementing the modified customer journey to eliminate the issues of the customer. For example, the issue identification system 110 may provide the modified customer journey to a customer service representative serving the customer, and the customer service representative may implement the modified customer journey to eliminate the issues of the customer. Alternatively, the issue identification system 110 may cause other mechanisms (e.g., a live chat, a chat bot, an IVR system, a POS system, a web application, and/or the like) to implement the modified customer journey for the customer and eliminate the issues of the customer. In this way, the issue identification system 110 may conserve computing resources, networking resources, and/or other resources that would have otherwise been consumed by failing to identify root causes of customer issues.

In some implementations, performing the one or more actions includes the issue identification system 110 providing the modified customer journey for display to the customer. For example, the issue identification system 110 may sequentially provide the events associated with the modified customer journey to the user device 105, and the user device 105 may sequentially display (or provide via audio) the events associated with the modified customer journey to the customer. In this way, the issue identification system 110 may conserve computing resources, networking resources, and/or other resources that would have otherwise been consumed by failing to identify the sequence patterns of the customer issues.

In some implementations, performing the one or more actions includes the issue identification system 110 providing the modified customer journey for display to a customer service representative. For example, the issue identification system 110 may sequentially provide the events associated with the modified customer journey to a device associated with a customer service representative serving the customer, and the device may sequentially display (or provide via audio) the events associated with the modified customer journey to the customer service representative. This may enable the customer service representative to implement the modified customer journey and eliminate the issues of the customer. In this way, the issue identification system 110 may conserve computing resources, networking resources, and/or other resources that would have otherwise been consumed by providing incorrect solutions to the customers.

In some implementations, performing the one or more actions includes the issue identification system 110 implementing the modified customer journey for one or more other customers. For example, since the modified customer journey eliminates the issues of the customer, the issue identification system 110 may identify one or more other customers similar to the customer. The issue identification system 110 may cause other mechanisms (e.g., live chats, chat bots, IVR systems, POS systems, web applications, and/or the like) to implement the modified customer journey for the one or more other customers and eliminate the issues of the one or more other customers. In this way, the issue identification system 110 may conserve computing resources, networking resources, and/or other resources that would have otherwise been consumed by causing longer resolution times and recurring customer problems.

In some implementations, performing the one or more actions includes the issue identification system 110 retraining the machine learning model based on the modified customer journey. For example, the issue identification system 110 may utilize the modified customer journey as additional training data for retraining the machine learning model, thereby increasing the quantity of training data available for training the machine learning model. Accordingly, the issue identification system 110 may conserve computing resources associated with identifying, obtaining, and/or generating historical data for training the machine learning model, relative to other systems for identifying, obtaining, and/or generating historical data for training machine learning models.

In some implementations, performing the one or more actions includes the issue identification system 110 utilizing a reactive approach with the modified customer journey. For example, when a customer faces an issue, the issue identification system 110 may provide a correct path that eliminates or minimizes the issue. In some implementations, performing the one or more actions includes the issue identification system 110 utilizing a proactive approach with the modified customer journey. For example, when a customer is associated with a path towards an issue, the issue identification system 110 may reroute the customer to a correct path without customer knowledge and to avoid the issue. Thus, the issue identification system 110 may support both reactive and proactive approaches. In some implementations, a customer service representative may be replaced with an IVR flow or a digital flow that eliminates human intervention.

In this way, the issue identification system 110 identifies customer issues utilizing causal and sequential patterns. For example, the issue identification system 110 may generate a knowledge graph based on digital channel data associated with a customer, and may process the knowledge graph, with a machine learning model, to identify issues associated with the customer. The issue identification system 110 may identify causal relationships between the issues, and may generate an inference score based on the causal relationships between the issues. The issue identification system 110 may modify a journey of the customer based on the inference score and to eliminate the issues associated with the customer. Thus, the issue identification system 110 may conserve computing resources, networking resources, and/or other resources that would have otherwise been consumed by failing to identify root causes of customer issues, failing to identify the sequence patterns of the customer issues, providing incorrect solutions to the customers, causing longer resolution times and recurring customer problems, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram illustrating an example 200 of training and using a machine learning model to identify customer issues utilizing causal and sequential patterns. The machine learning model training and usage described herein may be performed using a machine learning system. The machine learning system may include or may be included in a computing device, a server, a cloud computing environment, and/or the like, such as the issue identification system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the issue identification system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the issue identification system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of sequential events, a second feature of potential issues, a third feature of relationships, and so on. As shown, for a first observation, the first feature may have a value of sequential events 1, the second feature may have a value of potential issues 1, the third feature may have a value of relationships 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labeled “optimized graph” and may include a value of optimized graph 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of sequential events X, a second feature of potential issues Y, a third feature of relationships Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of optimized graph A for the target variable of the optimized graph for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a sequential events cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a potential issues cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to identify customer issues utilizing causal and sequential patterns. The machine learning system enables recognition and/or identification of tens, hundreds, thousands, or millions of features and/or feature values for tens, hundreds, thousands, or millions of observations, thereby increasing accuracy and consistency and reducing delay associated with identifying customer issues utilizing causal and sequential patterns relative to requiring computing resources to be allocated for tens, hundreds, or thousands of operators to manually identify customer issues utilizing causal and sequential patterns.

As indicated above, FIG. 2 is provided as an example. Other examples may differ from what is described in connection with FIG. 2.

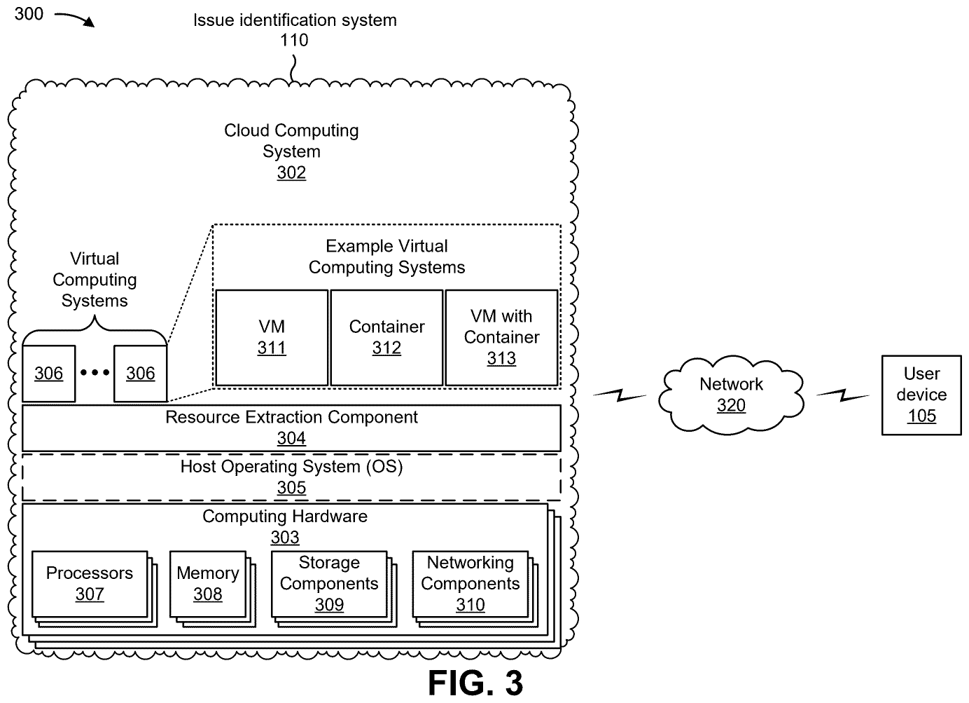

FIG. 3 is a diagram of an example environment 300 in which systems and/or methods described herein may be implemented. As shown in FIG. 3, the environment 300 may include the issue identification system 110, which may include one or more elements of and/or may execute within a cloud computing system 302. The cloud computing system 302 may include one or more elements 303-313, as described in more detail below. As further shown in FIG. 3, the environment 300 may include the user device 105 and/or a network 320. Devices and/or elements of the environment 300 may interconnect via wired connections and/or wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), an autonomous vehicle, a point-of-sale (POS) device, or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

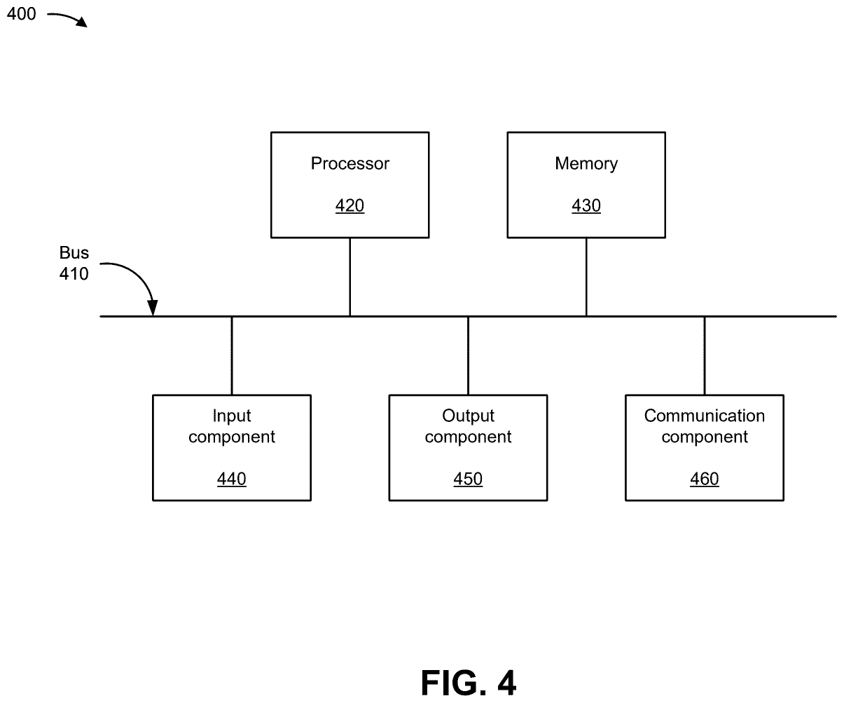

Although the issue identification system 110 may include one or more elements 303-313 of the cloud computing system 302, may execute within the cloud computing system 302, and/or may be hosted within the cloud computing system 302, in some implementations, the issue identification system 110 may not be cloud-based (e.g., may be implemented outside of a cloud computing system) or may be partially cloud-based. For example, the issue identification system 110 may include one or more devices that are not part of the cloud computing system 302, such as the device 400 of FIG. 4, which may include a standalone server or another type of computing device. The issue identification system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105 and/or the issue identification system 110. In some implementations, the user device 105 and/or the issue identification system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

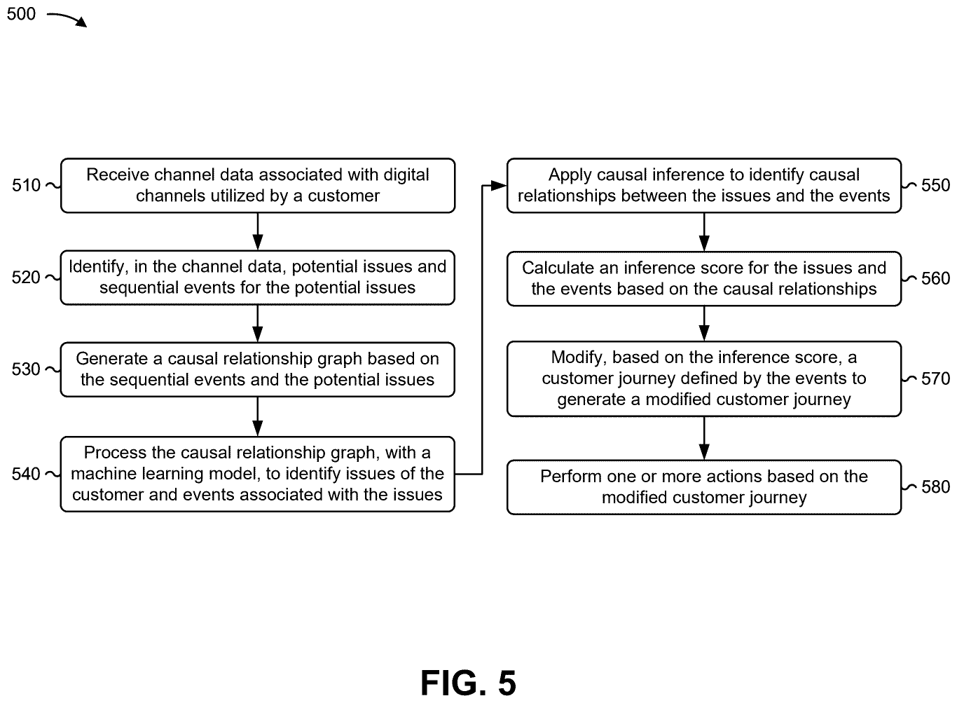

FIG. 5 is a flowchart of an example process 500 for identifying customer issues utilizing causal and sequential patterns. In some implementations, one or more process blocks of FIG. 5 may be performed by a device (e.g., the issue identification system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving channel data associated with digital channels utilized by a customer (block 510). For example, the device may receive channel data associated with digital channels utilized by a customer, as described above. In some implementations, the digital channels are associated with one or more of a telephone call, a live chat, an interactive voice response, an input to a chatbot, an input to a POS system, an input to a web application, or an input to a mobile application.

As further shown in FIG. 5, process 500 may include identifying, in the channel data, potential issues and sequential events for the potential issues (block 520). For example, the device may identify, in the channel data, potential issues and sequential events for the potential issues, as described above.

As further shown in FIG. 5, process 500 may include generating a causal relationship graph based on the sequential events and the potential issues (block 530). For example, the device may generate a causal relationship graph based on the sequential events and the potential issues, as described above. In some implementations, generating the causal relationship graph based on the sequential events and the potential issues includes mapping the sequential events to one or more of the potential issues, and creating a cross-issue sequential event mapping based on the sequential events and the potential issues. In some implementations, generating the causal relationship graph based on the sequential events and the potential issues includes identifying a set of the sequential events for each of the potential issues, mapping the set of the sequential events to each of the potential issues, and creating a cross-issue sequential event mapping based on the sequential events and the potential issues. In some implementations, the causal relationship graph is a knowledge graph with nodes that represent the sequential events and connectors, provided between the nodes, that represent relationships between the sequential events.

As further shown in FIG. 5, process 500 may include processing the causal relationship graph, with a machine learning model, to identify issues of the customer and events associated with the issues (block 540). For example, the device may process the causal relationship graph, with a machine learning model, to identify issues of the customer and events associated with the issues, as described above. In some implementations, processing the causal relationship graph, with the machine learning model, to identify the issues of the customer and the events associated with the issues includes utilizing the machine learning model to reduce a size of the causal relationship graph to include the issues of the customer and the events associated with the issues.

As further shown in FIG. 5, process 500 may include applying causal inference to identify causal relationships between the issues and the events (block 550). For example, the device may apply causal inference to identify causal relationships between the issues and the events, as described above. In some implementations, applying causal inference to identify the causal relationships between the issues and the events includes determining associations between the issues and the events, determining effects of interventions in the events based on the associations, and identifying the causal relationships between the issues and the events based on the effects of the interventions in the events.

As further shown in FIG. 5, process 500 may include calculating an inference score for the issues and the events based on the causal relationships (block 560). For example, the device may calculate an inference score for the issues and the events based on the causal relationships, as described above. In some implementations, the inference score provides an indication of a similarity between the issues and the events.

As further shown in FIG. 5, process 500 may include modifying, based on the inference score, a customer journey defined by the events to generate a modified customer journey (block 570). For example, the device may modify, based on the inference score, a customer journey defined by the events to generate a modified customer journey, as described above. In some implementations, the modified customer journey eliminates the issues of the customer.

As further shown in FIG. 5, process 500 may include performing one or more actions based on the modified customer journey (block 580). For example, the device may perform one or more actions based on the modified customer journey, as described above. In some implementations, performing the one or more actions based on the modified customer journey includes implementing the modified customer journey to eliminate the issues of the customer. In some implementations, performing the one or more actions based on the modified customer journey includes one or more of providing the modified customer journey for display to the customer, or providing the modified customer journey for display to a customer service representative associated with the customer. In some implementations, performing the one or more actions based on the modified customer journey includes implementing the modified customer journey for one or more other customers. In some implementations, performing the one or more actions based on the modified customer journey includes retraining the machine learning model based on the modified customer journey.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, channel data associated with digital channels utilized by a customer;
identifying, by the device and in the channel data, potential issues and sequential events for the potential issues;
generating, by the device, a causal relationship graph based on the sequential events and the potential issues;
processing, by the device, the causal relationship graph, with a machine learning model, to identify issues of the customer and events associated with the issues;
applying, by the device, causal inference to identify causal relationships between the issues and the events;
calculating, by the device, an inference score for the issues and the events based on the causal relationships;
modifying, by the device and based on the inference score, a customer journey defined by the events to generate a modified customer journey; and
performing, by the device, one or more actions based on the modified customer journey.

2. The method of claim 1, wherein generating the causal relationship graph based on the sequential events and the potential issues comprises:
mapping the sequential events to one or more of the potential issues; and
creating a cross-issue sequential event mapping based on the sequential events and the potential issues.

3. The method of claim 1, wherein generating the causal relationship graph based on the sequential events and the potential issues comprises:
identifying a set of the sequential events for each of the potential issues;
mapping the set of the sequential events to each of the potential issues; and
creating a cross-issue sequential event mapping based on the sequential events and the potential issues.

4. The method of claim 1, wherein processing the causal relationship graph, with the machine learning model, to identify the issues of the customer and the events associated with the issues comprises:
utilizing the machine learning model to reduce a size of the causal relationship graph to include the issues of the customer and the events associated with the issues.

5. The method of claim 1, wherein applying causal inference to identify the causal relationships between the issues and the events comprises:
determining associations between the issues and the events;
determining effects of interventions in the events based on the associations; and
identifying the causal relationships between the issues and the events based on the effects of the interventions in the events.

6. The method of claim 1, wherein the digital channels are associated with one or more of:
a telephone call,
a live chat,
an interactive voice response,
an input to a chatbot,
an input to a point-of-sale (POS) system,
an input to a web application, or
an input to a mobile application.

7. The method of claim 1, wherein the causal relationship graph is a knowledge graph with nodes that represent the sequential events and connectors, provided between the nodes, that represent relationships between the sequential events.

8. A device, comprising:
one or more processors configured to:
receive channel data associated with digital channels utilized by a customer;
identify, in the channel data, potential issues and sequential events for the potential issues;
generate a causal relationship graph based on the sequential events and the potential issues,
wherein the causal relationship graph is a knowledge graph with nodes that represent the sequential events and connectors, provided between the nodes, that represent relationships between the sequential events;
process the causal relationship graph, with a machine learning model, to identify issues of the customer and events associated with the issues;
apply causal inference to identify causal relationships between the issues and the events;
calculate an inference score for the issues and the events based on the causal relationships;
modify, based on the inference score, a customer journey defined by the events to generate a modified customer journey; and
perform one or more actions based on the modified customer journey.

9. The device of claim 8, wherein the inference score provides an indication of a similarity between the issues and the events.

10. The device of claim 8, wherein the modified customer journey eliminates the issues of the customer.

11. The device of claim 8, wherein the one or more processors, to perform the one or more actions based on the modified customer journey, are configured to:
implement the modified customer journey to eliminate the issues of the customer.

12. The device of claim 8, wherein the one or more processors, to perform the one or more actions based on the modified customer journey, are configured to one or more of:
provide the modified customer journey for display to the customer; or
provide the modified customer journey for display to a customer service representative associated with the customer.

13. The device of claim 8, wherein the one or more processors, to perform the one or more actions based on the modified customer journey, are configured to:
implement the modified customer journey for one or more other customers.

14. The device of claim 8, wherein the one or more processors, to perform the one or more actions based on the modified customer journey, are configured to:
retrain the machine learning model based on the modified customer journey.

15. A non-transitory computer-readable medium storing a set of instructions, the set of instructions comprising:
one or more instructions that, when executed by one or more processors of a device, cause the device to:
receive channel data associated with digital channels utilized by a customer,
wherein the digital channels are associated with one or more of a telephone call, a live chat, an interactive voice response, an input to a chatbot, an input to a point-of-sale (POS) system, an input to a web application, or an input to a mobile application;
identify, in the channel data, potential issues and sequential events for the potential issues;
generate a causal relationship graph based on the sequential events and the potential issues;
process the causal relationship graph, with a machine learning model, to identify issues of the customer and events associated with the issues;
apply causal inference to identify causal relationships between the issues and the events;
calculate an inference score for the issues and the events based on the causal relationships;
modify, based on the inference score, a customer journey defined by the events to generate a modified customer journey; and
perform one or more actions based on the modified customer journey.

16. The non-transitory computer-readable medium of claim 15, wherein the one or more instructions, that cause the device to generate the causal relationship graph based on the sequential events and the potential issues, cause the device to:
map the sequential events to one or more of the potential issues; and
create a cross-issue sequential event mapping based on the sequential events and the potential issues.

17. The non-transitory computer-readable medium of claim 15, wherein the one or more instructions, that cause the device to generate the causal relationship graph based on the sequential events and the potential issues, cause the device to:
identify a set of the sequential events for each of the potential issues;
map the set of the sequential events to each of the potential issues; and
create a cross-issue sequential event mapping based on the sequential events and the potential issues.

18. The non-transitory computer-readable medium of claim 15, wherein the one or more instructions, that cause the device to process the causal relationship graph, with the machine learning model, to identify the issues of the customer and the events associated with the issues, cause the device to:
utilize the machine learning model to reduce a size of the causal relationship graph to include the issues of the customer and the events associated with the issues.

19. The non-transitory computer-readable medium of claim 15, wherein the one or more instructions, that cause the device to apply causal inference to identify the causal relationships between the issues and the events, cause the device to:
determine associations between the issues and the events;
determine effects of interventions in the events based on the associations; and
identify the causal relationships between the issues and the events based on the effects of the interventions in the events.

20. The non-transitory computer-readable medium of claim 15, wherein the one or more instructions, that cause the device to perform the one or more actions based on the modified customer journey, cause the device to one or more of:
implement the modified customer journey to eliminate the issues of the customer;
provide the modified customer journey for display to the customer;
provide the modified customer journey for display to a customer service representative associated with the customer;
implement the modified customer journey for one or more other customers; or
retrain the machine learning model based on the modified customer journey.
